(19) United States
(12) Patent Application Publication
(10) Pub. No.: US 2008/0295035 A1
(43) Pub. Date: Nov. 27, 2008

(54) Projection of visual elements and graphical elements in a 3D UI

(75) Inventors: Jouka Mattila, Tampere (FI); Erika Reponen, Tampere (FI); Kaj Makela, Helsinki (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/807,146

(22) Filed: May 25, 2007

(51) Int. Cl. G06F 3/048

(52) U.S. Cl. 715/848

(57) ABSTRACT

A method includes determining user interface data based at least on a projection of visual element information from a projector at a first location in a three-dimensional space onto a screen object defined in the space. The screen object forms at least a portion of a user interface. The method includes determining an area of the screen object viewable by a camera positioned in a second location in the three dimensional space, and communicating the user interface data corresponding to the area to a display interface suitable for coupling to one or more displays. Apparatus and computer-readable media are also disclosed.

### TECHNICAL FIELD

This invention relates generally to electronic devices and, more specifically, relates to user interfaces in electronic devices.

### BACKGROUND

Most information presented by a computer is provided to a user through visual information on a user interface presented on a display. However, the ability of the user to perceive visual information is limited. One such limitation is the area of active vision, which is small due to physiological reasons, e.g., the structure of an eye. Another limitation occurs in the displays themselves. For instance, mobile devices in particular have small screens that need to present a wide range of information. At the same time, mobile devices need to provide a user with information such as the current interaction, connectivity, and status.

One technique being attempted, for both small and large displays, is to use a three-dimensional (3D) UI instead of a two-dimensional (2D) UI. A 3D UI has the potential to place more information into a smaller area.

A traditional 3D user interface (UI) is constructed from 3D objects that can be manipulated. The role of lights in the 3D space used to define the 3D UI is quite limited, as only object shadows and ambient lighting are generally shown. It is also well known that if a complex 3D UI would be constructed similarly to a 2D UI, the 3D UI would be larger in terms of file size (e.g., megabits). The file size of a 3D UI (e.g., which is proportional to the complexity of a 3D scene) is often considered the biggest obstacle to implementation of 3D UIs. Furthermore, this obstacle has been considered to reduce availability of 3D UIs. Consequently, there is currently no evolutionary stage between traditional 2D UIs and 3D UIs.

### BRIEF SUMMARY

In an exemplary embodiment, a method is disclosed that includes determining user interface data based at least on a projection of visual element information from a projector at a first location in a three-dimensional space onto a screen object defined in the space. The screen object forms at least a portion of a user interface. The method includes determining an area of the screen object viewable by a camera positioned in a second location in the three dimensional space, and communicating the user interface data corresponding to the area to a display interface suitable for coupling to one or more displays.

In another exemplary embodiment, an apparatus is disclosed that includes a display interface suitable for coupling to at least one display and includes at least one processor. The at least one processor is configured to determine user interface data based at least on a projection of visual element information from a projector at a location in a three-dimensional space onto a screen object defined in the space, wherein the screen object forms at least a portion of a user interface. The at least one processor is further configured to determine an area of the screen object viewable by a camera positioned in a second location in the three dimensional space, and the at least one processor is also configured to communicate the user interface data corresponding to the area to the display interface.

In an additional exemplary embodiment, a computer-readable medium is disclosed that includes program instructions tangibly embodied thereon. Execution of the program instructions result in operations including determining user interface data based at least on a projection of visual element information from a projector at a first location in a three-dimensional space onto a screen object defined in the space. The screen object forms at least a portion of a user interface. The operations also include determining an area of the screen object viewable by a camera positioned in a second location in the three dimensional space, and communicating the user interface data corresponding to the area to a display interface suitable for coupling to at least one display.

In a further exemplary embodiment, an apparatus includes means for determining user interface data based at least on a projection of visual element information from a projector at a first location in a three-dimensional space onto a screen object defined in the space, wherein the screen object forms at least a portion of a user interface. The apparatus also includes means for determining an area of the screen object viewable by a camera positioned in a second location in the three dimensional space and means for communicating the user interface data corresponding to the area to a display interface suitable for coupling to at least one display.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a simplified block diagram of an electronic device suitable for implementing the exemplary embodiments of the disclosed invention.

FIG. 2 is an example of a front view of a 3D UI.

FIG. 3 is an illustration of a 3D space used to create the front view shown in FIG. 2.

FIG. 4 is an example of a front view of a 3D UI created by projecting graphical elements onto a screen object (e.g., surface) of the UI.

FIG. 5 is an illustration of a 3D space used to create the front view shown in FIG. 4.

FIG. 6 is an example of a front view of a 3D UI having a shadow (e.g., silhouette).

FIG. 7 is an illustration of a 3D space used to create the front view shown in FIG. 7.

FIG. 8 is a flowchart of an exemplary method for 3D UI creation using projection of visual elements and graphical elements.

### DETAILED DESCRIPTION OF EXEMPLARY EMBODIMENTS

Another problem created by 3D UIs is that our visual sense is overloaded. Large amounts of information require a high amount of attention, and there are only few methods to vary the level of attention required. However, the user needs to be conveyed certain information to maintain awareness on, e.g., context and status of applications and connections. As visual resources are limited, the presented information needs to be prioritized, filtered, and visualized in an intuitive manner.

Certain exemplary embodiments of this invention solve this and other problems by using a projector in a 3D UI to project graphical elements, such as 2D opaque objects, particles, names, and the like. This can increase the information that can be conveyed. Furthermore, exemplary embodiments solve the problem of a non-existent evolutionary stage between 2D and 3D UIs, e.g., by using a projector in a 3D space. This makes the entire UI much easier to process and therefore it is possible to save in component prices of future devices. Additionally, when an analogue of a movie theatre is created with a 3D UI that uses a projector, it is possible to project 2D opaque objects onto a screen object (e.g., surface) of the UI. Such 2D opaque objects can be considered to be, e.g., an audience that is watching the show. This solves a problem of how it is possible to indicate participation of other users in same application; for example in virtual meeting software. This can be also used to show presence of a user in an application by using a shadow corresponding to the user.

Another aspect of exemplary embodiments is the ability to add particles to a 3D UI. Particles can be used to implicate various contextual meanings mainly using, e.g., various particle types, characteristics, and colors.

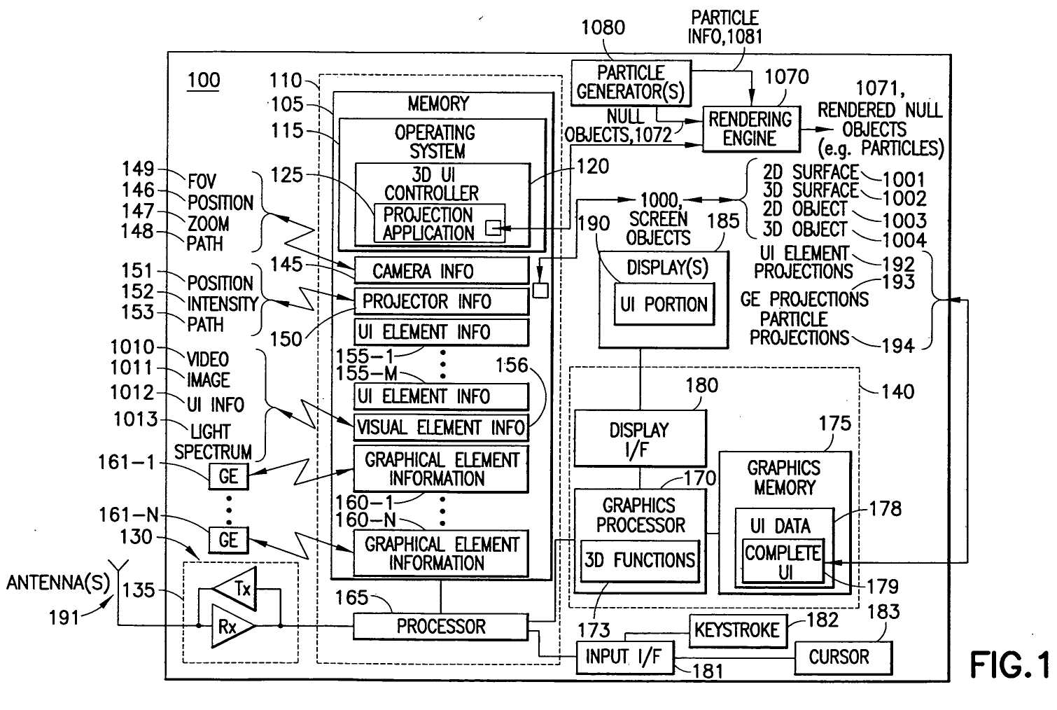

Reference is made to FIG. 1, which is a block diagram of an exemplary electronic device 100 suitable for use with certain exemplary embodiments of the disclosed invention. The electronic device 100 includes three interconnected integrated circuits 135, 110, and 140 and one or more displays 185. The electronic device 100 may also include or be coupled to one or more antennas 191. The integrated circuit 135 includes a transceiver 130 having at least one receiver, Rx, and at least one transmitter, Tx.

The integrated circuit 110 includes a memory 105 coupled to a processor 165. It is noted that there could be multiple memories 105 and multiple processors 165. The memory 105 includes an operating system 115, which includes a 3D UI controller 120, virtual camera information 145, virtual projector information 150, UI element information 155-1 through 155-M, visual element information 156, graphical element data 160-1 through 160-N, and a screen object 1000. The screen object 1000 in a non-limiting embodiment can be a 2D surface 1001, 3D surface 1002, a 2D object 1003 (e.g., a 2D surface plus texture, coloring, and other effects), or a 3D object (e.g., a 3D surface plus texture, coloring, and other effects). The 3D UI controller 120 includes a projection application 125.

The integrated circuit 140 includes a graphics processor 170, a graphics memory 175, and a display interface (I/F) 180. The graphics processor 170 includes a number of 3D functions 173. The graphics memory 175 includes UI data 178, which includes data from a complete UI 179. The one or more displays 185 include a UI portion 190, which is a view of the complete UI 179 such that the UI portion 190 includes some or all of the complete UI 179. The electronic device 100 also includes an input interface 181, a keystroke input device 182 (e.g., a keypad or keyboard), and a cursor input device 183 (e.g., a mouse or trackball). The keystroke input device 182 and cursor input device 183 are shown as part of the electronic device 100 but could also be separate from the electronic device 100, as could display(s) 185.

In this example, the 3D UI controller 120 is responsible for generation and manipulation of the UI portion 190 and the corresponding UI data 178. The UI data 178 is a representation of the UI portion 190 shown on the one or more displays 185, although the UI data 178 includes a complete UI 179. The projection application 125 projects (using a virtual projector at least partially defined by the projector information 150) the visual element information 156 onto the screen object 1000 of the complete UI 179. In one exemplary embodiment, a virtual projector (discussed below) projects an image 1011, a video 1010, or UI information 1012, as non-limiting examples. In another embodiment, the virtual projector projects a light spectrum 1013, such as white light, although the content of red, green, and blue in the light can be modified, along with gamma, grey scale, and other projector functions. In this embodiment, the UI information 1012 could be desktop material that is presented on the screen object 1000.

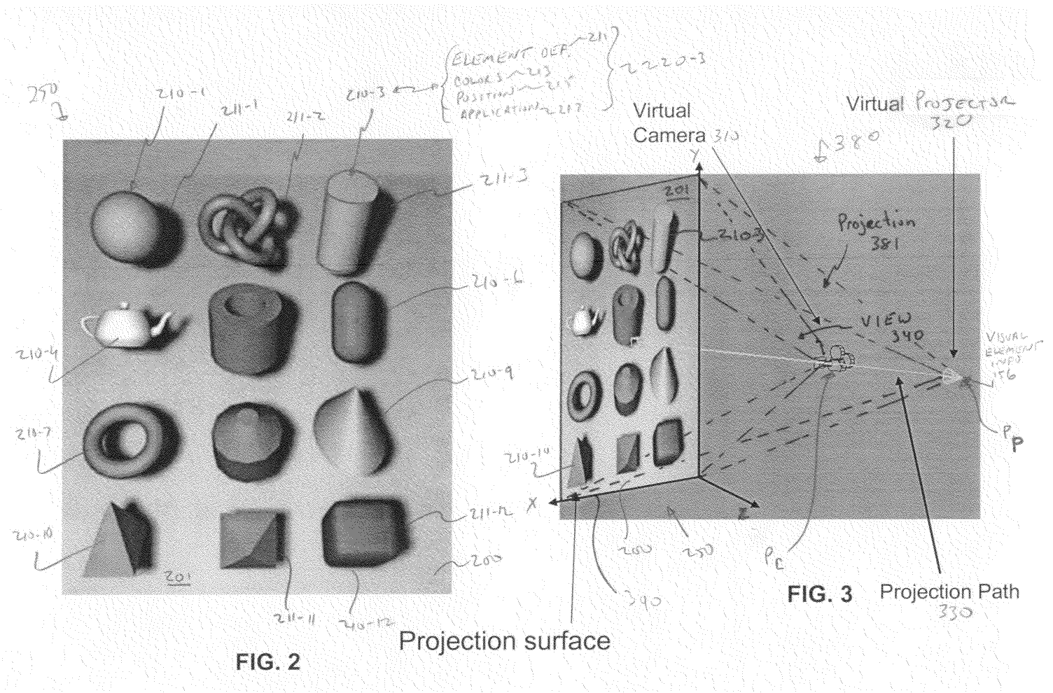

The projection application 125 also determines how UI elements 151 influence the projected visual element information 151 and create projected UI elements (e.g., UI element projections 192) on the screen object 1000 of the complete UI 179. The UI elements (shown in FIGS. 2 and 3) are elements a user uses to interact with applications (not shown) executed by the processor 165. In an exemplary embodiment, the projection application 125 includes a rendering engine 1070. It is noted that part or all of rendering engine 1070 may also reside in graphics processor 170, depending on implementation. As described in more detail below, the rendering engine 1070 can use particle information 1081 from one or more particle generators 1080 and use null objects 1072, and will produce rendered null objects 1071 (e.g., as part of the complete UI 179).

The projection application 125 is also used to project the visual element information 156 onto the screen object 1000 and to determine an interaction of the graphical elements (GEs) 161-1 through 161-N (more specifically, the interaction with the graphical element information 160-1 through 160-N) with the projected visual element information 156. The determination of the interaction results in the projections (e.g., GE projections 193) of the graphical elements 161 onto the screen object 1000 of the complete UI 179. The graphical element information 160 can be thought of as defining corresponding graphical elements 161. The projection application 125 uses the UI element information 155, the projector information 150, the visual element information 156, and the graphical element information 160 to create (e.g., and update) the complete UI 179 in UI data 178. The complete UI 179 therefore includes UI element projections 192 (corresponding to interaction of UI element information 155 with the projected visual element information 151) and graphical element (GE) projections 193 (corresponding to interaction of graphical element information 160 with a projection of the visual element information 156). The particle projections 194 are the projections caused on the complete UI 179 by the rendered null objects 1071.

The virtual camera information 145 contains information related to a virtual camera, such as in a non-limiting embodiment position 146 (e.g., <x₁, y₁, z₁>) of the camera in a 3D space, zoom 147, path 148, and field of view 149 (FOV). In an exemplary embodiment, path 148 is a vector from the position 146 through the 3D space and is positioned at a center of a view of the virtual camera. In another non-limiting embodiment, the path 148 could be an ending location in 3D space and a vector could be determined using the position 146 and the ending location. Any other information suitable for defining a view of a virtual camera may be used. The projector information 150 contains information regarding a virtual projector used to project the visual element information 156 in the 3D space, and can include position 151 (e.g., <x₂, y₂, z₂>) of the virtual projector, intensity 152 of light from the virtual projector, and a path 153. The path 153 is similar to the path 148 and defines (in an exemplary embodiment) the orientation of a center of the projected light from the virtual projector. The FOV 149 is well known and may be calculated at least in part using the zoom 147.

The graphics processor 170 includes 3D functions 173 that might be used by the 3D UI controller, for instance, for shading, color modification, and the like.

It is noted that FIG. 1 is merely exemplary. There may be fewer, more, or no integrated circuits, for example. The graphics processor 170 could be combined with the processor 165. Similarly, the memories 105 and 175 could be combined.

In general, the various embodiments of the electronic device 100 can include, but are not limited to, cellular telephones, personal digital assistants (PDAs), portable computers, image capture devices such as digital cameras, gaming devices, music storage and playback appliances, Internet appliances permitting wireless Internet access and browsing, as well as portable units or terminals that incorporate combinations of such functions. The electronic device 100 may or may not have wireless communication capabilities.

Turning to FIGS. 2 and 3 in addition to FIG. 1, in FIG. 2 an example is shown of a front view of a 3D UI 250 (e.g., UI portion 190 as shown on display(s) 185). In FIG. 3, an illustration is shown of a 3D space 380 used to create the front view shown in FIG. 2. The 3D UI 250 includes a number of UI elements 210-1 through 210-12, each of which is defined by UI element information 220 (e.g., UI element information 155). The screen object 1000 is a 2D surface 201. In this example, only the UI element information 220-3, corresponding to UI element 210-3, is shown. UI element information 220-3 includes, e.g., an element definition 211, which defines the shape of the element (a cylinder in this example), colors 213, which define the color palette used for the element, position 215, which defines a location on the surface 201 (e.g., or in the 3D space 380), and an associated application 217 (i.e., stored in memory 105 of FIG. 1) to which events corresponding to manipulation of the UI element 210-3 would be sent. The UI element information 220-3 is merely exemplary. It is also noted that the UI elements may be assigned to a plane in the 3D space, as described in reference to FIG. 5.

The front view of the 3D UI 250 is created using the 3D space 380. The 3D space 380 includes the axes x, y, and z, and the surface 201 is in this example, which is in the x-y plane. The 3D space 380 further includes the virtual camera 310, at a position P_{C} in the 3D space 380, and a virtual projector 320 at position Pₚ in the 3D space 380. The virtual projector 320 projects along a projection path 330, and the virtual camera 310 has a center point along this path, too, although this is merely exemplary. The virtual camera 310 and virtual projector 320 can be placed in any position in the 3D space 380.

In an exemplary embodiment, the virtual projector 320 projects (e.g., as projection 381) the visual element information 156 onto the surface 201. The projection 381 creates the background 200 on the surface 201. The projection 381 also interacts with the UI elements 210, which creates, e.g., shadows 211-1 through 211-12 and may also create other lighting effects. In another exemplary embodiment, the background 200 is formed on the surface 201 by using UI information 1012, and the virtual projector 320 projects (as projection 381) a light spectrum 1013 (e.g., white light). The projection 381 also interacts with the UI elements 210, which creates, e.g., shadows 211-1 through 211-12 and may also create other lighting effects.

Exemplary embodiments of the disclosed invention include visualization techniques and apparatus for 3D user interfaces that work in electronic devices that utilize 3D rendering as visual output. Such 3D rendering, as shown for instance in FIGS. 2 and 3 and other figures described below, provides a metaphor of image projection in a 3D user interface, and utilizes spatial characteristics of 3D environment (e.g., shadowing and occlusion of objects) to present information. In an exemplary embodiment, a virtual projector casts (using projection 381) graphical elements, such as images, objects, particles, or textures, to 3D surfaces, as shown in for example FIG. 3. The resulting projected image is affected by the graphical elements (e.g., UI elements 210) being between the virtual projector 320 and the surface 201. The graphical elements are used, e.g., to present information and these elements can appear as shadows, particle layers, or silhouettes in a view (e.g., 390) of the UI that is presented to a user.

The visual element information 156 can any visual element, e.g. a whole UI, video, and/or an image file. The visual element information 156 is projected to the surface 201 in a 3D environment (e.g., 3D space 380) and the image is examined by the virtual camera that is in virtual space as well. The virtual camera 310 defines the view 340 displayed for the user. The view 340 further defines the viewable area 390 of the UI. The viewable area 390 is a limited area of the 3D space 380. The viewable area 390 can include all or a portion of the UI 250.

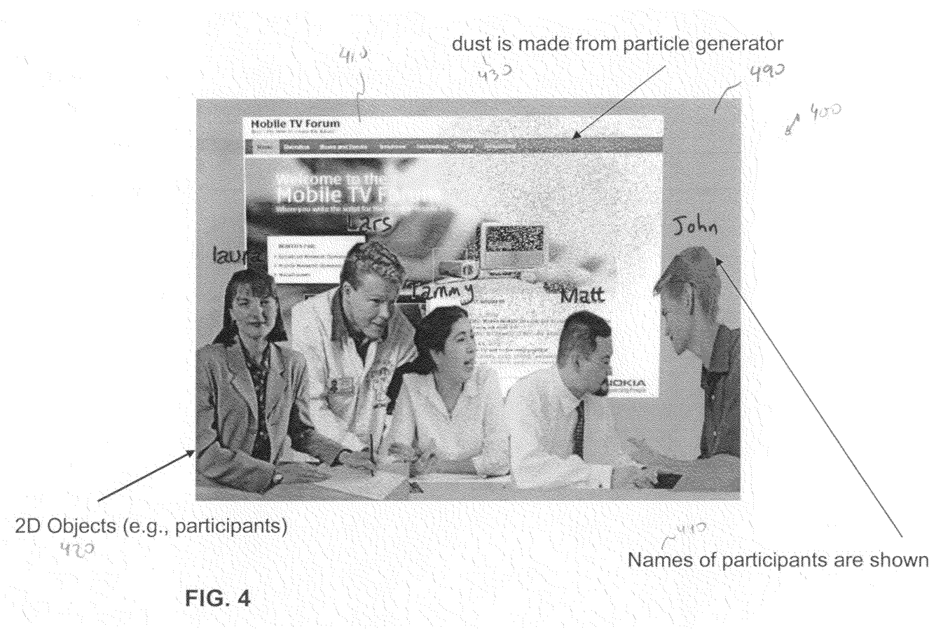

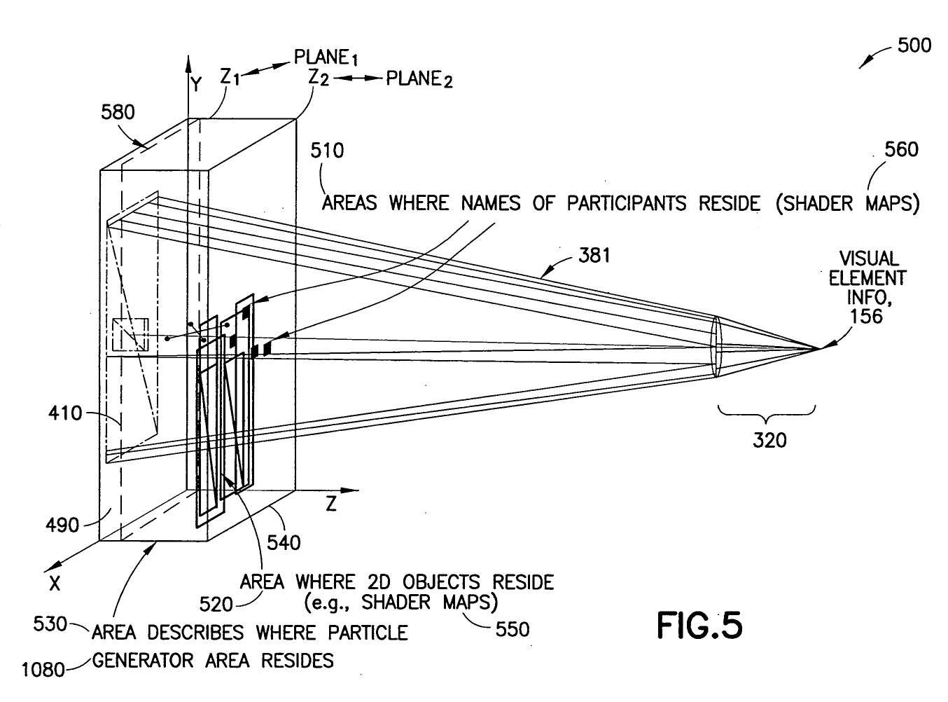

A user sees the projected view 340 in a similar way as to non-projected light, but the spatial capabilities of a 3D environment are used along with analogue manifestations. This combination provides analogues of places like, e.g., a movie theatre, where people in front of the projection form silhouettes to the projected images. This enables, in an exemplary embodiment, the presentation of information by utilizing a notion of shadowing (e.g., masking). Virtual objects or particles between the virtual projector 156 and the surface 201 appear on the surface as shadows or changed textures (see FIGS. 4 and 5, for instance).

Exemplary embodiments herein allow interaction between the user and the UI to be used as well, even if the UI is only a projection as shown in FIG. 3. For instance, as described above, in an exemplary embodiment, a UI has its own projection file (e.g., visual element information 156) that can be still image or animation. This type of UI is browsed for example like a slide show or an Interactive TV (television) show. Using objects (see FIGS. 4 and 5, described below) and their shadows, exemplary embodiments herein allow users to see information that appears on the screen and that overlays and supplements existing information. This supplemental information is available to be perceived, but does not occupy the whole visual channel or capture all of the attention of the user. When this additional information is visualized in a subtle way, this presentation offers a far better UI than most existing UIs in, for example, mobile devices, and PCs (personal computers), where basically all additional information appears in pop-up boxes.

The virtual projector 320 is the light source in the 3D space 380 and this light is in an exemplary embodiment free form light, although other lighting techniques may be used. A purpose of the virtual projector 320 is to project any visual information (e.g., embodied in the visual element information 156) to objects that the projector 320 is “facing”. Projector light from the virtual projector 320 also lightens up all objects that the projector faces, but such lighting is dependant on the attenuation values and fall-off values of the virtual projector 320. These tell in which range projected image and light is visible and where the light starts to decay disappearing at an end point, and these can be considered part of intensity information 152.

In 3D space 380, the presentation of the UI is based on mathematics and some of the phenomena that appear in a real world will not necessarily happen in exactly the same way in 3D space 380. This means that it is harder to mimic reality than to make unrealistic presentations in a 3D programming environment. So, the laws of the optics (and, e.g., physics) do not necessarily happen in the 3D space 380, although the laws can certainly be simulated.

A user sees the projected image (e.g., of the projection 381 and its interaction with objects placed between the virtual projector 320 and the surface 201) via the virtual camera 310 that is in the 3D space 380. The field of vision (e.g., view 340) of the camera 310 should be the same as the fall off range of the projector light from the virtual projector 320. When these two values match, the user sees exactly the same image that is projected to the surface 201. Also, the surface 201 where image is projected should be at a right-angle towards the view of the camera (e.g., or to the center point of the camera) so that image does not distort, unless distortion is for some reason desired. It is also noted that if a more complex screen object 1000 is used, such as a 3D object 1004, the image might not be projected at a right angle to much or all of the surface of the screen object 1000.

Additional elements that were mentioned earlier, such as 3D objects, silhouettes, and particles that are between a surface 201 (e.g., a screen object) and the projector 320 can effect the projected image, improving the analogue to a movie theatre. See the description of FIGS. 4 and 5, below. In virtual 3D space 380, light does not necessarily need to cast any shadows or lighten up any surface that the light hits. Using this as an advantage, a designer can create novel visualizations for collaboration software, as shown in FIGS. 4 and 5.

Turning now to FIGS. 4 and 5, FIG. 4 is an example of a front view of a 3D UI 400 created by projecting visual element information 156 onto a surface 490 (e.g., an example of a screen object 1000) of the UI and having the projection 381 interact with graphical elements prior to striking the surface 490. FIG. 5 is an illustration of a 3D space 500 used to create the front view shown in FIG. 4. The visual element information 156 in this example includes the browser window 410. The 2D objects 420 (e.g., pictures of participants), names 440 of the participants, and dust 430 (made from a particle accelerator) are the results of interaction between the projection 381 and corresponding graphical elements.

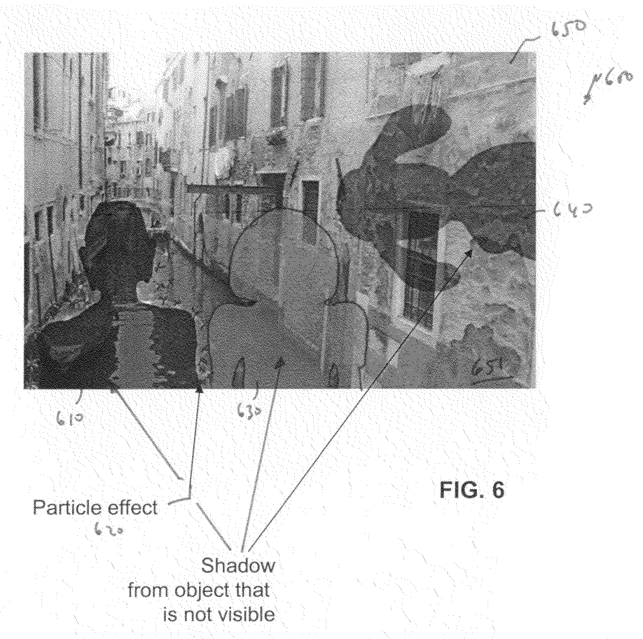

For instance, pictures of persons that appear in the example of FIG. 4 are 2D objects 420 that are based on the graphical elements of opacity shader maps 550 (e.g., placed at area 520). The pictures are rectangular, but they have mask maps that causes all information that surrounds a silhouette of a person to be ignored. This presentation can also be made using this mask map only (see FIG. 6). It is beneficial to use opacity shader maps, because these maps save file size in polygon count. A drawback can be a large amount of textures that cause relatively long rendering times, but using shader maps within certain limits will be beneficial. The layer where these shaded images exist is called in this example shader layer 540.

Shader layer 540 also includes areas 510 (e.g., the graphical elements of shader maps 560) that cause the names 440 to be generated in response to an interaction with the projection 381. In this example, shader layer 540 is a plane (plane₁) parallel to the (x, y) plane at a location of z₂ along the z axis. Also, a particle generator (a graphical element) can “reside” anywhere within the area 530. A typical particle generator 1080 is in an exemplary embodiment a dynamic object that generates null objects 1072 that do not have any volume, but a rendering engine 1070 generates the visual appearance of the null objects 1072 that is based on information 1081 that a certain particle generator 1080 provides. For example, a rain-particle generator 1080 offers information 1081 to the rendering engine 1070 that the engine 1070 will draw rain-like graphics when the engine 1070 is rendering the particle generator's burst of null objects 1072. Null object 1072 means that in an editing tool one can see null objects 1072 as, e.g., tiny crosses, but the final appearance of the rendered null objects 1071 is decided in the rendering engine 1070. The particles (e.g., rendered null objects 1071) can appear to be generated anywhere within area 530, which means that a particle generator will appear to “reside” within the area 530. The particle information 1081 can indicate source location(s) for the particles.

Shader maps (e.g., shader maps 550) appear in a material side, which means typically as input to the rendering engine 1070 (e.g., the projection application 125). The material side is typically separated from the rendering side. In other words, particle generation typically takes place during rendering by the rendering engine 1070, while shader maps are usually inputs to the rendering engine 1070. One material (e.g., graphical element information 160) can have multiple shader maps. It is noted that shader maps (e.g., shader maps 550) can also be offered to the rendering engine 1070, which will then render a shader effect. It is noted that many 3D editing tools can show some shader map information in an editing space too, but the final effect is usually visible on the rendering side only.

FIG. 5 also shows an object layer 580, which in this example is defined as a plane (plane₁) parallel to the (x, y) plane, at a location z₁ along the z axis. The UI elements 210 are the objects that typically would reside in the object layer 580. Information regarding the planes plane₁ and plane₂ can be used when projecting graphical or UI elements. In another exemplary embodiment, each graphical or UI element has its own location in the 3D space 500.

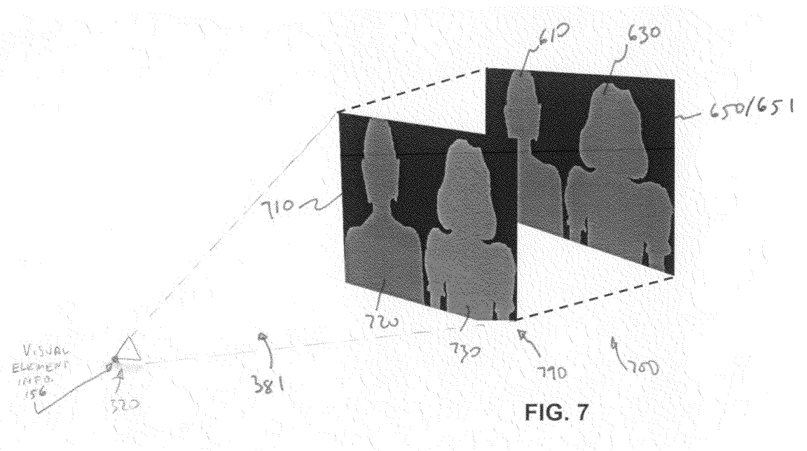

Referring now to FIGS. 6 and 7 in addition to previously described figures, FIG. 6 is an example of a front view of a 3D UI 600 having a number of shadows 610, 630, and 640 (e.g., silhouettes), and FIG. 7 is an illustration of a 3D space 700 used to create the front view shown in FIG. 7. FIGS. 6 and 7 represent another example of how particles and different colored shader maps (also called “opacity maps”) on 2D objects look. A particle effect 620 is shown. In this example, the shadows 610, 640 are different colors than the shadow 630 when projected onto the surface 651. The visual element information 156 is in this example a background 650 that is projected onto the surface 651 (e.g., an example of a screen object 1000).

The shadows 610, 630 are created using a shader map 770 placed between the virtual projector 320 and the surface 651. The area 710 of the shader map 770 indicates that nothing is to happen in this area (i.e., the projected image in this area remains unchanged). In other words, in a shader map, black areas are transparent and colors are opaque. The portions 720 and 730 indicate the coloring and affect the resultant projected image in the projection 381 of the visual element information 156, to form the shadows 610, 630, respectively.

3D objects (such as UI elements 210) could also be used as graphical elements, and in some cases a 3D object would be better than a 2D version of the object. For instance, certain 3D icons could be brought directly between the projector light caused by the virtual projector 320 and a surface to cause shadows that could indicate, for example, notification of incoming phone call. These 3D objects then could also include texture maps that require mapping coordinates. Particles that were visible in FIGS. 4 and 6 come from a particle field that can exist between a surface (e.g., screen object) and shader layer (e.g., 540)/3D objects (a first solution) or between shader (e.g., 540)/3D objects layer and camera 310 (a second solution). The first solution is used in the example of FIG. 4 because that matches better with an analogue of a movie theatre.

These particles are made using a particle generator 1080. In an exemplary embodiment, a particle generator 1080 is an object where special effects happen. The boundaries of objects are also limits where this effect happens. Typical effects are rain, snow, wind, and smoke (see, e.g., FIG. 6). One use for this is that particles visualize contextual information that information on, e.g., a shader layer 1080 cannot necessarily show. Also, how these particles move may offer another level of information about their characteristics and meanings.

UI navigation can be performed, for example with a cursor. Cursor location is recognized by following the position of the on the screen (e.g., display(s) 185). This screen contains the viewing area (e.g., view 340) of the camera 310, which user sees as a 3D world. In other words, in an exemplary embodiment, the cursor does not exist in the 3D world at all, but instead lies in an area between the user and the 3D space. For instance, the cursor location in an x, y grid is matched to the projected image on the screen. In this projected image, there are known areas that are links. When the cursor is in same areas as the links, interactivity is possible. This of course demands that the screen object (e.g., surface 201) is in same position as the display is. The comments given above show one example of implementation, though others are also possible.

Below is a list about exemplary elements of exemplary embodiments of the disclosed invention:

1. Surface to be projected: any 2D or 3D object element having surface able to display resulting image projections and shadows/silhouettes;

2. Virtual camera: defines the view (e.g., scope) the user sees, typically a first-person viewpoint;

3. Virtual projector: virtual source of light and image projection;

4. Objects: two- or three-dimensional objects, located between the projector and the surface, typically in an object layer;

5. Particles to be presented: typically located between projector and shader layer or between surface and object layer; and

6. Shadows, textures, shader maps on the surfaces of the objects: both on screen object or on objects in shader level.

Surfaces, viewpoints of the camera, objects, and the projector can be panned and rotated in a three dimensional space (e.g., six degrees-of-freedom) to create new compositions. The virtual camera can use zooming and other optical changes to crop and transform the projected image. Objects created using shadows (e.g., silhouettes) can be used to present subtle secondary information in the UI. Such objects can be two- or three-dimensional. The objects may be created based on captured real-world information or may be created entirely virtually. For example, the following objects might be used: A mask created from an image of a person, e.g. in a contact card; or a mask created from some imaginary object/character that represents the person as, e.g., an avatar (e.g., a horse character for Erika, a sports car for Mike). Resulting “shadow areas” (e.g., 610, 630, 640 of FIG. 6) may vary in texture to indicate different concepts, e.g., these areas can be formed from dust cluster, such as a blurry star-shaped area in a view.

In an exemplary embodiment, creation and utilization is supported for real-time personal masks in a mobile device. One example of a technique for creating an object representing a person in different contexts is as follows. A person has a mobile device having a camera that is positioned to point toward the user. The image of the person is captured from the camera, possibly continuously as video information. Image content from the camera is analyzed to create a virtual object (i.e., mask object) from the image of the person captured from the camera of the mobile device when the user is viewing the screen. The shader/mask object of the user is extracted from this captured image by recognizing the edges of the person. There are many automatic mask capture programs already existing and their methods are well known in area of computer science. This mask object is then used as a 2D object in the 3D UI to form shadows (e.g., silhouettes) of the user in the UI to create the impression that there is a light/projection source behind the user causing the shadow/silhouette to the front of the user in UI. As the mask object of the user is captured continuously from the camera, the 2D mask object can be animated.

The resulting mask object can be displayed also on other UIs of other users as a shadow (e.g., silhouette) when sharing or viewing the same content at the same time or participating same teleconference. This supports social awareness on co-viewers and participants. When changes occur, e.g., people stop viewing or exit the session, the shadows change and user is able to notice the event.

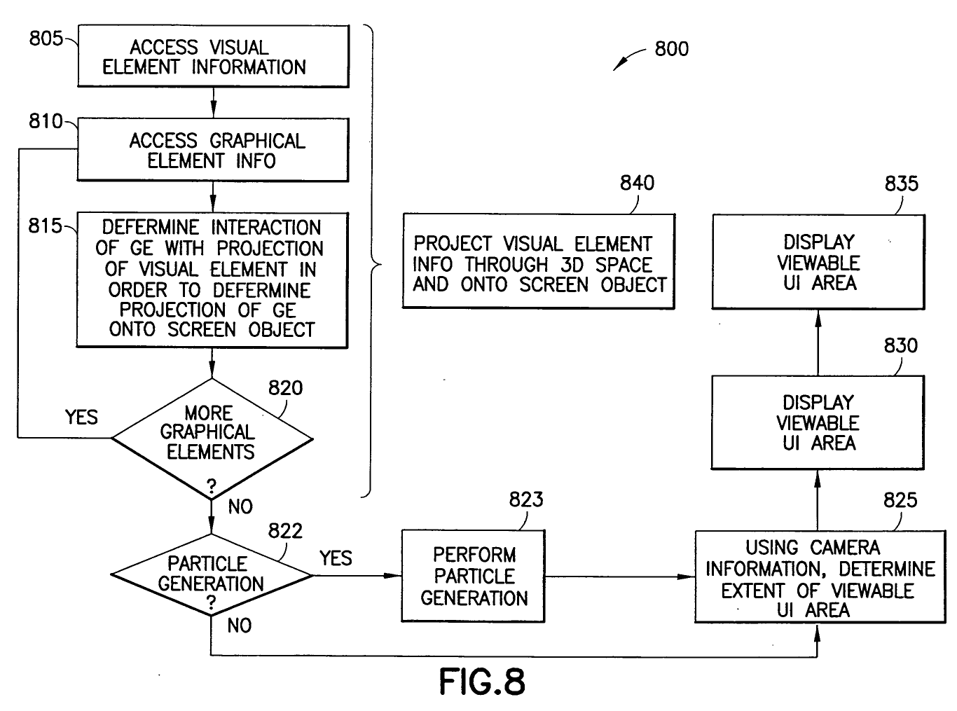

Referring now to FIG. 8 in addition to previous figures, a flowchart is shown of an exemplary method 800 for 3D UI creation using projection of visual elements and graphical elements. Method 800 would be performed by, e.g., projection application 125 (and, e.g., other elements under the control of the projection application 125) of FIG. 1. In block 805, the visual element information 156 is accessed. Such information, as previously discussed, can include one or more of a video 1010, an image 1011, or UI information 1012 (e.g., including an application window and/or a background as non-limiting examples). The visual element information 156 could also be a light spectrum 1013, and the virtual projector will project the light spectrum onto a surface that contains the UI information 1012.

In block 810, the graphical element information 160 is accessed for a chosen graphical element. In the example of FIG. 8, graphical elements include UI elements. Thus, block 815 includes both accessing UI element information 155 and graphical element information 160. In block 815, the interaction is determined between the graphical element information and the projection 381 of the visual element information 156. This interaction allows a determination to be made of the projection of the graphical element onto the screen object 1000 of the UI. The interaction can include, e.g., an occlusion, opacity shading, and any other effects caused by a graphical element placed between a surface and a projector that projects visual element information. In block 820, it is determined if there are additional graphical elements. If so (block 820=Yes), graphical element information 160 is selected corresponding to another graphical element 161 and the method 800 continues in block 810. It is noted that the blocks 805 through 820 are considered to be block 840, in which visual element information 156 is projected through the 3D space and onto the screen object 1000.

If not (block 820=No), it is determined in block 822 if particle generation is to be performed. If particle generation is to be performed (block 822=YES), then particle generation is performed (block 823), e.g., using one or more particle generators 1080. If particle generation is not to be performed (block 822=NO) or after particle generation is performed, the extent of viewable area (e.g., defined view 340) of the complete UI 179 is determined, based on the camera information 145. This occurs in block 825. In block 830, the viewable area 390 of the complete UI 179 and the UI (e.g., UI portion 190) is communicated, e.g. to the display interface 180, in block 830. Such communication could be to the display(s) 185, such that the UI portion 190 is displayed (block 835) on the display(s) 185.

Exemplary embodiments of the disclosed invention have one or more of the following non-limiting advantages:

1) Provides utilization of the peripheral perception of people to decrease the information overflow and maintain status awareness;

2) Provides utilization of existing knowledge on the behavior of light in the real world, decreasing the learning curve of understanding the visualized information

3) Offers a possible middle ground between the traditional 2D UI and full 3D UI;

4) Allows use of existing UI in a 3D space;

5) Provides a UI having a smaller file size than file sizes from a fully 3D UI;

6) Provides additional information (e.g., in particle layer and shader layer) that can be presented to a user in a far more subtle and intuitive way than existing solutions with pop-up boxes in both PC and mobile environments.

It should be noted that the various blocks of the logic flow diagram of FIG. 8 might represent program actions, or interconnected logic circuits, blocks and functions, or a combination of program actions and logic circuits, blocks and functions.

The memory 105 may be of any type suitable to the local technical environment and may be implemented using any suitable data storage technology, such as semiconductor-based memory devices, magnetic memory devices and systems, optical memory devices and systems, fixed memory and removable memory. The processors 165, 170 may be of any type suitable to the local technical environment, and may include one or more of general purpose computers, special purpose computers, microprocessors, video processors, digital signal processors (DSPs), and processors based on a multi-core processor architecture, as non-limiting examples. Embodiments of the disclosed invention may be implemented as a computer-readable medium comprising computer-readable program instructions tangibly embodied thereon, execution of the program instructions resulting in operations The computer-readable medium can be, e.g., the memory 105, a digital versatile disk (DVD), a compact disk (CD), a memory stick, or other long or short term memory.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the scope of this invention.

Furthermore, some of the features of exemplary embodiments of this invention could be used to advantage without the corresponding use of other features. As such, the foregoing description should be considered as merely illustrative of the principles of embodiments of the present invention, and not in limitation thereof.

What is claimed is:

1. A method comprising:
determining user interface data based at least on a projection of visual element information from a projector at a first location in a three-dimensional space onto a screen object defined in the space, wherein the screen object forms at least a portion of a user interface;
determining an area of the screen object viewable by a camera positioned in a second location in the three dimensional space; and
communicating the user interface data corresponding to the area to a display interface suitable for coupling to at least one display.

2. The method of claim 1, wherein the screen object comprises a plane in the space.

3. The method of claim 1, wherein the screen object comprises a three-dimensional surface in the space.

4. The method of claim 1, wherein the visual element information comprises at least one of a video, at least one image, or user interface information.

5. The method of claim 1, wherein the visual element information comprises a light spectrum.

6. The method of claim 1, further comprising displaying the portion of the user interface on the at least one display.

7. The method of claim 1, wherein the projection is modified at least in part through interaction between the projection and at least one graphical element positioned in the space between the projector and the screen object.

8. The method of claim 7, wherein one of the at least one graphical elements comprises a shader map.

9. The method of claim 8, wherein the shader map corresponds to one of an image or a video.

10. The method of claim 7, wherein one of the at least one graphical elements comprises a two-dimensional object and interaction of the two dimensional object with the projection causes a corresponding shadow on the screen object.

11. The method of claim 10, wherein the two-dimensional object is based on a picture.

12. The method of claim 11, wherein another of the at least one graphical elements comprises indicia of a name, and wherein the indicia is placed in the space such that interaction of the indicia with the projection causes a name on the screen object that is proximate the shadow.

13. The method of claim 1, wherein the projection is modified at least in part by particles generated in the space using at least one particle generator.

14. The method of claim 7, wherein the at least one graphical element is defined to reside at least in part on a plane between the projector and the screen object.

15. The method of claim 7, wherein one of the at least one graphical elements comprises a user interface element associated with an application.

16. The method of claim 15, wherein the at least one user interface element is defined to reside at least in part on a plane between the projector and the screen object.

17. The method of claim 1, wherein determining an area further comprises determining the area of the screen object viewable by a camera using at least a field of view of the camera.

18. An apparatus comprising:
a display interface suitable for coupling to at least one display; and
at least one processor, the at least one processor configured to determine user interface data based at least on a projection of visual element information from a projector at a location in a three-dimensional space onto a screen object defined in the space, wherein the screen object forms at least a portion of a user interface, the at least one processor further configured to determine an area of the screen object viewable by a camera positioned in a second location in the three dimensional space, and the at least one processor also configured to communicate the user interface data corresponding to the area to the display interface.

19. The apparatus of claim 18, wherein the at least one processor is implemented on at least one integrated circuit.

20. The apparatus of claim 18, wherein the screen object comprises one of a plane in the space or a three-dimensional surface in the space.

21. The apparatus of claim 18, wherein the visual element information comprises at least one of a video, at least one image, or user interface information.

22. The apparatus of claim 18, wherein the visual element information comprises a light spectrum.

23. The apparatus of claim 18, wherein the projection is modified at least in part through interaction between the projection and at least one graphical element positioned in the space between the projector and the screen object.

24. The apparatus of claim 23, wherein one of the at least one graphical elements comprises a shader map.

25. The apparatus of claim 23, wherein one of the at least one graphical elements comprises a two-dimensional object and interaction of the two dimensional object with the projection causes a corresponding shadow on the screen object.

26. The apparatus of claim 18, wherein at least one processor implements at least one particle generation and wherein the projection is modified at least in part by particles generated in the space using the at least one particle generator.

27. The apparatus of claim 23, wherein the at least one graphical element is defined to reside at least in part on a plane between the projector and the screen object.

28. The apparatus of claim 23, wherein one of the at least one graphical elements comprises a user interface element associated with an application.

29. The apparatus of claim 23, wherein the at least one user interface element is defined to reside at least in part on a plane between the projector and the screen object.

30. The apparatus of claim 18, wherein determining an area further comprises determining the area of the screen object viewable by a camera using at least a field of view of the camera.

31. A computer-readable medium comprising program instructions tangibly embodied thereon, execution of the program instructions resulting in operations comprising:
determining user interface data based at least on a projection of visual element information from a projector at a first location in a three-dimensional space onto a screen object defined in the space, wherein the screen object forms at least a portion of a user interface;
determining an area of the screen object viewable by a camera positioned in a second location in the three dimensional space; and
communicating the user interface data corresponding to the area to a display interface suitable for coupling to at least one display.

32. The computer-readable medium of claim 31, wherein the visual element information comprises at least one of a video, at least one image, or user interface information.

33. The computer-readable medium of claim 31, wherein the visual element information comprises a light spectrum.

34. The computer-readable medium of claim 31, wherein the projection is modified at least in part through interaction between the projection and at least one graphical element positioned in the space between the projector and the screen object.

35. An apparatus comprising:
means for determining user interface data based at least on a projection of visual element information from a projector at a first location in a three-dimensional space onto a screen object defined in the space, wherein the screen object forms at least a portion of a user interface;
means for determining an area of the screen object viewable by a camera positioned in a second location in the three dimensional space; and
means for communicating the user interface data corresponding to the area to a display interface suitable for coupling to at least one display.
